(19) United States
(12) Patent Application Publication
(10) Pub. No.: US 2009/0021803 A1
(43) Pub. Date: Jan. 22, 2009

(54) IMAGE READING APPARATUS, IMAGE-READING PROCESSING APPARATUS, IMAGE READING METHOD, AND COMPUTER PROGRAM PRODUCT

(75) Inventor: Yoshiyasu TAGAWA, Ishikawa (JP)

Correspondence Address: LOWE HAUPTMAN HAM & BERNER, LLP, 1700 DIAGONAL ROAD, SUITE 300, ALEXANDRIA, VA, 22314, US

(73) Assignee: PFU LIMITED, ISHIKAWA (JP)

(21) Appl. No.: 12/114,278

(22) Filed: May 2, 2008

(30) Foreign Application Priority Data
Jul. 18, 2007 (JP) 2007-187353

(51) Int. Cl. H04N 1/04

(52) U.S. Cl. 358/488

(57) ABSTRACT

An image reading apparatus includes a flatbed image reading unit, an ADF image reading unit, a storage unit, and a control unit, wherein the control unit includes a flatbed image-reading control unit that controls the flatbed image reading unit to read an image of a read-condition setting sheet, and stores the image of the read-condition setting sheet in the storage unit, a read-condition determining unit that determines a read condition from the image of the read-condition setting sheet read by the flatbed image-reading control unit, a read-condition setting unit that sets a read condition for a document to be read by the ADF image reading unit according to the read condition determined by the read-condition determining unit, and an ADF image-reading control unit that controls the ADF image reading unit to read an image of the document according to the read condition set by the read-condition setting unit, and stores the image of the document in the storage unit.

### BACKGROUND OF THE INVENTION

1. Field of the Invention

The present invention relates to an image reading apparatus, an image reading processing apparatus, an image reading method, and a computer program product.

2. Description of the Related Art

Examples of a conventional image reading apparatus that can be applied to such as image scanners, photocopiers, facsimile machines, and character recognition systems include, for example, an image reading apparatus equipped with a flatbed image reading mechanism (hereinafter referred to as “flatbed image reading unit”), and an image reading apparatus equipped with an auto document feeder image reading mechanism (hereinafter referred to as “ADF image reading unit”). The flatbed image reading unit reads image information of a medium such as a book or a magazine by placing the medium on a platen, and moving a line image sensor with respect to the medium. The ADF image reading unit reads image information of a stack of sheet-like media by successively feeding the stack of the media, and moving the media with respect to a stationary line image sensor. The flatbed image reading apparatus can read a medium that is relatively thick such as a book or a magazine because this type of image reading apparatus reads the medium by placing the medium on the platen, and covering the medium with a document holding cover that can be opened and closed freely with respect to the platen. On the other hand, the ADF image reading apparatus can automatically transport a large quantity of sheet-like media, and read images of the media because this type of image reading apparatus can perform image reading processing by successively, and individually feeding the stack of the media. Further, some of the ADF image reading apparatuses can cope with media of more than one size.

In image data accumulation method described in JP-A-63-284966, a file name has to be specified every time data changes when a plurality of pieces of data are accumulated in an accumulating unit. Therefore, a mark sensing card that specifies a target storage in which the data should be stored is used as a first piece of a document to be read, and image data of the remaining pieces of the document are stored in the target storage by reading the mark sensing card.

Further, a scanning apparatus described in JP-A-2002-354212 addresses a problem of the conventional scanning apparatuses performing read setting using a dedicated sheet such as a mark sensing card that an entire piece of the document is read at high-resolution even when it is not necessary to read at high-resolution or the entire piece of the document, resulting in unnecessarily increased reading time required for reading an image. Therefore, the scanning apparatus of JP-A-2002-354212 is provided with such as a setting key for setting a mode for reading a dedicated sheet so that, in the mode for reading a dedicated sheet, the reading is performed for a predetermined range at a predetermined resolution using predetermined image processing, which makes it possible to reduce time necessary for reading the dedicated sheet.

However, with the conventional image reading apparatus such as image scanners, reading resolution and various setting parameters must be set each time according to a type of a document to be read. On the other hand, when a read condition is fixed, while setting is not necessary, it is not possible in some cases to obtain desired image corresponding to the type of the document to be read.

In particular, with the method described in JP-A-2002-354212, while making a dedicated sheet describing a read condition to be read a first piece of the document makes it unnecessary to set the read condition for the remaining pieces of the document, because the method described in JP-A-2002-354212 is an image reading apparatus that includes only the ADF image reading unit, the read condition cannot be changed until the reading of the document is completed once the read condition is set. Accordingly, there is a problem that it is not possible in some cases to obtain desired image corresponding to the document to be read when reading a plurality of documents.

### SUMMARY OF THE INVENTION

It is an object of the present invention to at least partially solve the problems in the conventional technology.

An image reading apparatus according to one aspect of the present invention includes a flatbed image reading unit, an ADF image reading unit, a storage unit, and a control unit, wherein the control unit includes a flatbed image-reading control unit that controls the flatbed image reading unit to read an image of a read-condition setting sheet, and stores the image of the read-condition setting sheet in the storage unit, a read-condition determining unit that determines a read condition from the image of the read-condition setting sheet read by the flatbed image-reading control unit, a read-condition setting unit that sets a read condition for a document to be read by the ADF image reading unit according to the read condition determined by the read-condition determining unit, and an ADF image-reading control unit that controls the ADF image reading unit to read an image of the document according to the read condition set by the read-condition setting unit, and stores the image of the document in the storage unit.

An image-reading processing apparatus according to another aspect of the present invention including a storage unit and a control unit is connected to an image reading apparatus including a flatbed image reading unit and an ADF image reading unit, wherein the image-reading processing apparatus includes a flatbed image-reading control unit that controls the flatbed image reading unit to read an image of a read-condition setting sheet, and stores the image of the read-condition setting sheet in the storage unit, a read-condition determining unit that determines a read condition from the image of the read-condition setting sheet read by the flatbed image-reading control unit, a read-condition setting unit that sets a read condition for a document to be read by the ADF image reading unit according to the read condition determined by the read-condition determining unit, and an ADF image-reading control unit that controls the ADF image reading unit to read an image of the document according to the read condition set by the read-condition setting unit, and stores the image of the document in the storage unit.

An image reading method according to still another aspect of the present invention is executed by an image reading apparatus including a flatbed image reading unit, an ADF image reading unit, a storage unit, and a control unit, wherein the method includes a flatbed image-reading control step of controlling the flatbed image reading unit to read an image of a read-condition setting sheet, and storing the image of the read-condition setting sheet in the storage unit, a read-condition determining step of determining a read condition from the image of the read-condition setting sheet read at the flatbed image-reading control step, a read-condition setting step of setting a read condition for a document to be read by the ADF image reading unit according to the read condition determined at the read-condition determining step, and an ADF image-reading control step of controlling the ADF image reading unit to read an image of the document according to the read condition set at the read-condition setting step, and storing the image of the document in the storage unit.

A computer program product according to still another aspect of the present invention, having a computer readable medium including programmed instructions for executing an image reading method by an image reading apparatus including a flatbed image reading unit, an ADF image reading unit, a storage unit, and a control unit, wherein the instructions, when executed by a computer, cause the computer to perform a flatbed image-reading control step of controlling the flatbed image reading unit to read an image of a read-condition setting sheet, and storing the image of the read-condition setting sheet in the storage unit, a read-condition determining step of determining a read condition from the image of the read-condition setting sheet read at the flatbed image-reading control step, a read-condition setting step of setting a read condition for a document to be read by the ADF image reading unit according to the read condition determined at the read-condition determining step, and an ADF image-reading control step of controlling the ADF image reading unit to read an image of the document according to the read condition set at the read-condition setting step, and storing the image of the document in the storage unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating a physical configuration of an image reading apparatus according to the present invention;

FIG. 2 is a diagram illustrating a logical configuration of the image reading apparatus according to the present invention;

FIG. 3 is a diagram illustrating one example of read-condition setting sheet according to the present invention;

FIG. 4 is a flowchart showing a basic operation of one embodiment according to the present invention;

FIG. 5 is a flowchart showing an operation in a high-speed reading mode of the embodiment according to the present invention;

FIG. 6 is a flowchart showing an operation of processing of changing the read condition in the embodiment according to the present invention.

### DETAILED DESCRIPTION OF THE PREFERRED EMBODIMENTS

The following describes an embodiment of an image reading apparatus, an image-reading processing apparatus, an image reading method, and a computer program product for such an apparatus and a method according to the present invention in detail with reference to the drawings. The embodiment is illustrative only, and is not intended to limit the present invention in any way.

### Outline

The following first outlines the present invention, and then, a configuration and processing of the present invention are explained in detail.

The present invention generally has the following basic technical features. Specifically, an image reading apparatus according to the present invention includes a flatbed image reading unit that reads a read-condition setting sheet, an ADF image reading unit that reads a document, a storage unit, and a control unit.

First of all, in the present invention, the flatbed image reading unit is controlled to read an image of the read-condition setting sheet.

As used herein, the “read-condition setting sheet” refers to a sheet that describes a read condition for a document to be read by the ADF image reading unit. Further, the form of the read-condition setting sheet can be either sheet-like (for example, a mark sensing card) or book-like (for example, an instruction manual).

Next, in the present invention, the read condition is determined from the image of read-condition setting sheet that has been read. In the present invention, the read condition described in the read-condition setting sheet can be determined using such as optical character recognition (OCR), and pattern recognition.

Further, the “read condition” is a read condition for a document to be read by the ADF image reading unit, and relates to, for example, setting for a reading mode, resolution, setting between black-and-white and color, and black-and-white image processing setting. As used herein, examples of the reading mode that can be set include such as a normal reading mode, and a high-speed reading mode in which an image of the next piece of the document is read while processing an image of the current piece of the document.

Thereafter, in the present invention, a read condition for the document to be read by the ADF image reading unit is set according to the read condition that has been determined.

As used herein, the “document” refers to a read medium including a single or a plurality of sheets that are to be read by the ADF image reading unit.

Next, in the present invention, the ADF image reading unit is controlled according to the read condition that has been set to read the image of the document.

### Configuration of the Image Reading Apparatus

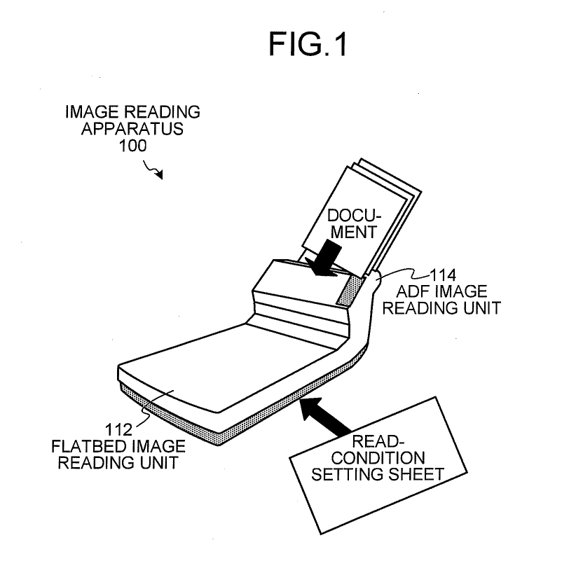

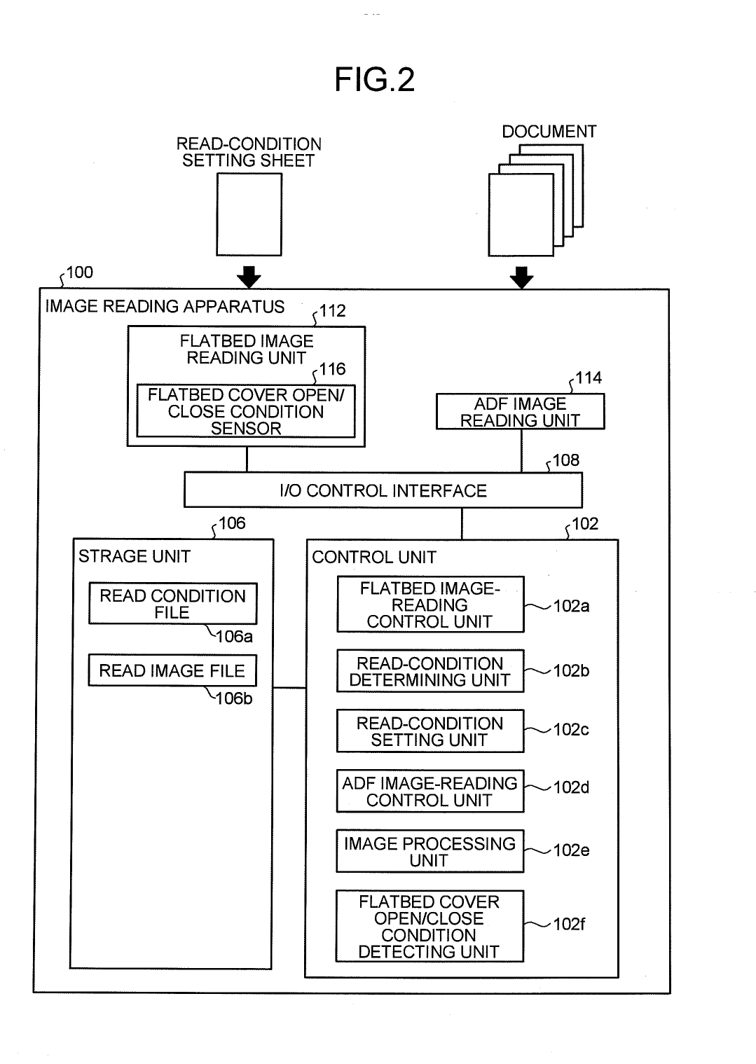

The following first describes a configuration of an image reading apparatus 100. FIG. 1 and 2 schematically shows components that relates to the present invention in this configuration.

As shown in FIG. 1, the image reading apparatus 100 includes a flatbed image reading unit 112, and an ADF image reading unit 114.

As used herein, the flatbed image reading unit 112 is a flatbed image reading mechanism that reads image information of a medium such as a book or a magazine by placing the medium on a platen, and moving a line image sensor with respect to the medium. As used herein, the flatbed image reading unit 112 includes a flatbed cover open/close condition sensor such as an optical sensor, and a pressure-sensitive sensor, that detects whether a flatbed cover of the flatbed image reading unit 112 is open or closed.

As used herein, the ADF image reading unit 114 is an auto document feeder image reading mechanism that reads image information of a stack of sheet-like media by successively feeding the stack of the media, and moving the media with respect to a stationary line image sensor.

As shown in FIG. 2, the image reading apparatus 100 according to the present invention schematically includes a control unit 102 such as a CPU that controls the entire operation of the image reading apparatus 100, an input/output (I/O) control interface 108 that is connected to such as the flatbed image reading unit 112 and the ADF image reading unit 114, and a storage unit 106 that stores various databases and tables. These components are communicably connected one another via an arbitrary communication channel.

Referring to FIG. 2, the various databases and tables stored in the storage unit 106 are storage units such as a fixed disk drive, and stores various programs, tables, files, and databases that are used for various processing.

Among the components of the storage unit 106, a read condition file 106a stores a read condition that has been determined based on an image of the read-condition setting sheet that has been read by the flatbed image reading unit 112.

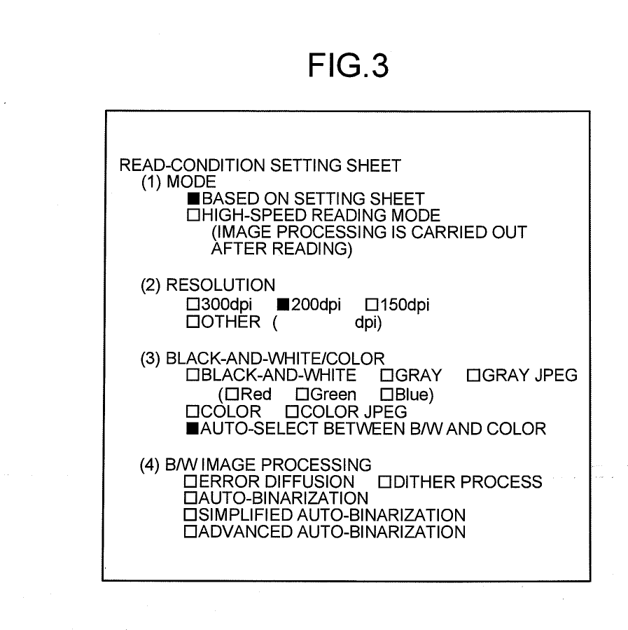

One example of the read condition that is stored in the read condition file 106a is explained with reference to FIG. 3.

As shown in FIG. 3, information stored in the read condition file 106a relates to, for example, setting for the reading mode (corresponding to (1) in FIG. 3), setting for resolution (corresponding to (2) in FIG. 3), setting between black-and-white and color (corresponding to (3) in FIG. 3), or setting for black-and-white image processing (corresponding to (4) in FIG. 3). In FIG. 3, the setting is such that the reading mode is the normal mode, the resolution 200 dpi, the setting between black-and-white and color is auto-selection between black-and-white/color.

As used herein, the “setting for the reading mode” is the setting for the reading mode when reading the document by the ADF image reading unit 114, and includes, as shown in (1) in FIG. 3, such as the “normal reading mode” (corresponding to “based on the setting sheet” in FIG. 3) in which normal reading is carried out, and the “high-speed reading mode” in which an image of the next piece of the document is read while processing an image of the current piece of the document.

As used herein, the “setting for the resolution” is the setting for the resolution when the image of the document is read, and it is possible to set, as shown in (2) in FIG. 3, for example, to 300 dpi, 200 dpi, 150 dpi, or an arbitrary resolution.

As used herein, the “setting between black-and-white and color” is the setting for selection of a color in which the image of the document that has been read is shown, and it is possible to set, as shown in (3) in FIG. 3, for example, to black-and-white, gray, red, green, blue, or auto-selection.

As used herein, the “setting for black-and-white image processing” is the image processing setting when selecting the black-and-white in the setting between black-and-white and color, and it is possible to as shown in (4) in FIG. 3, select, for example, error diffusion, dither process, or binarization.

Again referring to FIG. 2, a read image file 106b stores an image of the document that has been read by the ADF image reading unit 114 according to the read condition. The read image file 106b can store image data after the image has been processed.

Further, in FIG. 2, the I/O control interface 108 controls such as the flatbed image reading unit 112 provided with the flatbed cover open/close condition sensor 116, and the ADF image reading unit 114.

Further, in FIG. 2, the control unit 102 includes a control program such as an Operating System (OS), a program that defines various procedures, and an internal memory that stores necessary data, and performs information processing to carry out various processing according to these programs, and such. The control unit 102 functionally includes a flatbed image-reading control unit 102a, a read-condition determining unit 102b, a read-condition setting unit 102c, an ADF image-reading control unit 102d, an image processing unit 102e, and a flatbed cover open/close condition detecting unit 102f.

Among these, the flatbed image-reading control unit 102a controls the flatbed image reading unit 112 via the I/O control interface 108 to read an image of the read-condition setting sheet.

Further, the read-condition determining unit 102b determines the read condition from the image of the read-condition setting sheet that has been read by the flatbed image-reading control unit 102a.

Further, the read-condition setting unit 102c sets the read condition for the documents to be read by the ADF image reading unit 114, by storing the read condition that has been determined by the read-condition determining unit 102b in the read condition file 106a.

Further, the ADF image-reading control unit 102d controls, according to the read condition set in the read condition file 106a by the read-condition setting unit 102c, the ADF image reading unit 114 via the I/O control interface 108 to read a document, and stores the image that has been read in the read image file 106b.

Further, the image processing unit 102e carries out image processing such as error diffusion, dither process, and auto-binarization according to the read condition set in the read condition file 106a, to the image data that has been read by the ADF image-reading control unit 102d and stored in the read image file 106b, and stores the processed image data in the read image file 106b.

Further, the flatbed cover open/close condition detecting unit 102f controls the flatbed cover open/close condition sensor 116, and detects whether the flatbed cover of the flatbed image reading unit 112 is open or closed.

### Processing of Image Reading Apparatus

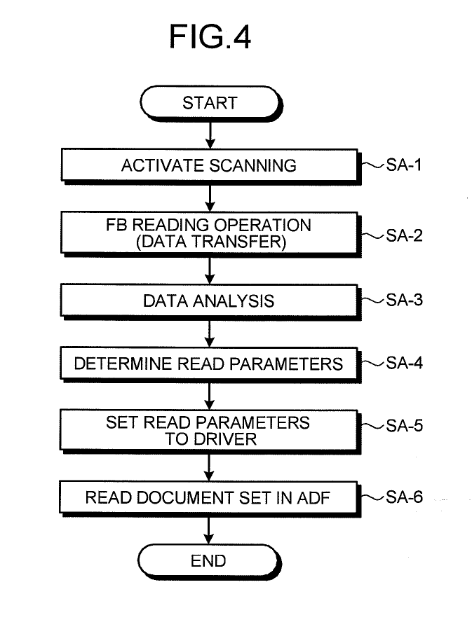

The following describes in detail one example of processing of the image reading apparatus 100 according to the present embodiment as configured above with reference to FIG. 4 through FIG. 6.

### Basic Operation

Now, processing in a basic operation of the present invention is explained with reference to FIG. 4. FIG. 4 is a flowchart showing a basic operation of one embodiment according to the present invention.

First, when the image reading apparatus 100 is activated (Step SA-1), the flatbed image-reading control unit 102a controls the flatbed image reading unit 112 via the I/O control interface 108 to read an image from the read-condition setting sheet (Step SA-2). At this time, the read-condition setting sheet is placed on the flatbed image reading unit 112.

Next, the read-condition determining unit 102b analyzes the image of the read-condition setting sheet that has been read by the flatbed image-reading control unit 102a to determine the read condition (Step SA-3), and determines read parameters as the read condition determined by the read-condition determining unit 102b (Step SA-4). Specifically, the read-condition determining unit 102b determines the read condition described in the read-condition setting sheet by carrying out such as OCR, and pattern recognition based on the image of the read-condition setting sheet, thereby determining the read parameters.

Then, the read-condition setting unit 102c sets the read condition for the document to be read by the ADF image reading unit 114 according to the read parameters determined by the read-condition determining unit 102b (Step SA-5).

Then, the ADF image-reading control unit 102d controls the ADF image reading unit 114 via the I/O control interface 108 according to the read condition set by the read-condition setting unit 102c to read an image from the document (Step SA-6).

At this time, the image processing unit 102e can carry out image processing such as error diffusion, dither process, and auto-binarization to the image that has been read by the ADF image-reading control unit 102d.

As described above, the image reading apparatus 100 controls the flatbed image reading unit 112 to read the image of the read-condition setting sheet, determines the read condition based on the image of the read-condition setting sheet that has been read, sets the read condition for the ADF image reading unit 114 according to the read condition that has been determined, and reads the image of the document by controlling the ADF image reading unit 114 according to the read condition that has been set. With such a configuration, it is not necessary to set reading resolution, and various setting parameters each time according to a type of a document to be read, thereby facilitating the setting of the read condition, and in turn reducing reading time required for reading a document.

### Setting for High-Speed Reading Mode

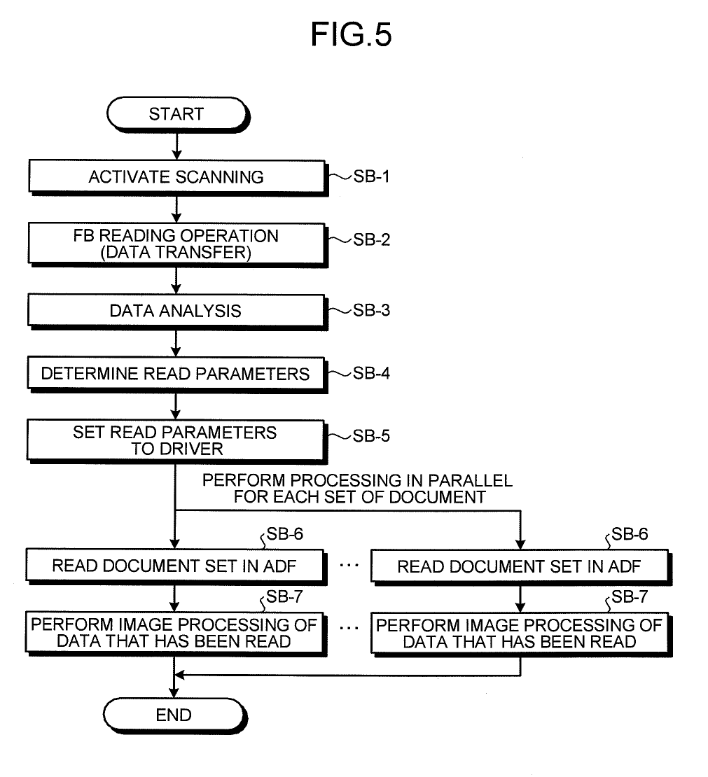

The following describes in detail the image reading processing of the image reading apparatus 100 according to the present embodiment as configured above when the reading mode of the read-condition setting sheet is determined to be the high-speed reading mode with reference to FIG. 5. In this explanation, Step SB-1 through Step SB-6 in FIG. 5 respectively corresponds to Step SA-1 through Step SA-6 in FIG. 4.

First, when the image reading apparatus 100 is activated (Step SB-1), the flatbed image-reading control unit 102a controls the flatbed image reading unit 112 via the I/O control interface 108 to read an image from the read-condition setting sheet (Step SB-2). At this time, the read-condition setting sheet is placed on the flatbed image reading unit 112.

Next, the read-condition determining unit 102b analyzes the image of the read-condition setting sheet that has been read by the flatbed image-reading control unit 102a to determine the read condition (Step SB-3), and determines read parameters as the read condition determined by the read-condition determining unit 102b (Step SB-4). Specifically, the read-condition determining unit 102b determines the read condition described in the read-condition setting sheet to be a high-speed reading mode by carrying out such as OCR, and pattern recognition based on the image of the read-condition setting sheet, thereby determining to perform reading with the read condition of the high-speed reading.

Then, the read-condition setting unit 102c sets the read condition for the document to be read by the ADF image reading unit 114 according to the read parameters determined by the read-condition determining unit 102b (Step SB-5). Specifically, the read-condition setting unit 102c sets the high-speed reading mode in which an image of the next piece of the document is read while processing an image of the current piece of the document.

Then, when it is set to be the high-speed reading mode by the read-condition setting unit 102c, the ADF image-reading control unit 102d controls the ADF image reading unit 114 via the I/O control interface 108 to read an image from the document (Step SB-6), and the image processing unit 102e carries out image processing to the image of the document that has been read by the ADF image-reading control unit 102d (Step SB-7), and while the image processing is being carried out by the image processing unit 102e, the ADF image-reading control unit 102d controls the ADF image reading unit 114 to read an image of the next document that is newly set to the ADF image reading unit 114 (Step SB-6). Specifically, in the high-speed reading mode, the processing of reading the document by the ADF image-reading control unit 102d, and the image processing of the image of the document by the image processing unit 102e are carried out in parallel for each set of the document.

As described above, with the image reading apparatus 100 according to the present embodiment, when the read condition that has been determined is the high-speed reading mode, the image of the next piece of the document is read while the processing of the image of the document is performed. As a result, a different batch process for reading can be carried out in parallel, thereby allowing an increase in the speed of an entire reading operation.

### Processing of Changing Read Condition

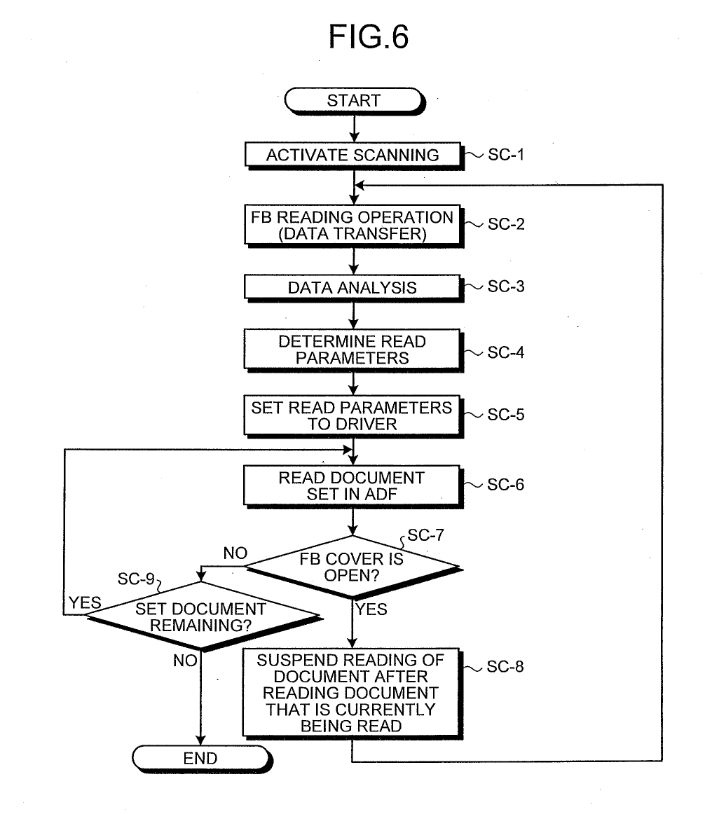

The following describes in detail the image reading processing of the image reading apparatus 100 according to the present embodiment as configured above regarding an example in which, the image reading processing is suspended when the flatbed cover of the flatbed image reading unit 112 is open while reading of the image of the document, and then resumed after the read condition is re-set with reference to FIG. 6. In this explanation, Step SC-1 through Step SC-6 in FIG. 6 respectively correspond to Step SA-1 through Step SA-6 in FIG. 4.

First, when the image reading apparatus 100 is activated (Step SC-1), the flatbed image-reading control unit 102a controls the flatbed image reading unit 112 via the I/O control interface 108 to read an image from the read-condition setting sheet (Step SC-2). At this time, the read-condition setting sheet is placed on the flatbed image reading unit 112.

Next, the read-condition determining unit 102b analyzes the image of the read-condition setting sheet that has been read by the flatbed image-reading control unit 102a to determine the read condition (Step SC-3), and determines read parameters as the read condition determined by the read-condition determining unit 102b (Step SC-4). Specifically, the read-condition determining unit 102b determines the read condition described in the read-condition setting sheet by carrying out such as OCR, and pattern recognition based on the image of the read-condition setting sheet, thereby determining the read parameters.

Then, the read-condition setting unit 102c sets the read condition for the document to be read by the ADF image reading unit 114 according to the read parameters determined by the read-condition determining unit 102b (Step SC-5).

Then, the ADF image-reading control unit 102d controls the ADF image reading unit 114 via the I/O control interface 108 by the read-condition setting unit 102c to read an image from the document (Step SC-6).

At this time, the image processing unit 102e can carry out image processing such as error diffusion, dither process, and auto-binarization to the image that has been read by the ADF image-reading control unit 102d.

Then, while reading of the image of the document, the flatbed cover open/close condition detecting unit 102f controls the flatbed cover open/close condition sensor 116 of the flatbed image reading unit 112 to detect whether the flatbed cover (not shown) is open or closed (Step SC-7).

In this example, when the flatbed cover open/close condition detecting unit 102f detects that the flatbed cover is open (Step SC-7: Yes), then the ADF image-reading control unit 102d controls the ADF image reading unit 114 to suspend the reading of the document after reading the document that is currently being read (Step SC-8).

Then, when the flatbed cover open/close condition detecting unit 102f detects that the flatbed cover of the flatbed image reading unit 112 is closed by the flatbed cover open/close condition sensor 116, the operation returns to Step SC-1, and the processing from Step SC-2 through Step SC-6 is repeated to re-set the read condition, and an ADF image-reading control unit 102e controls the ADF image reading unit 114 to resume the reading of the document (Step SC-2 through Step SC-6).

Returning to Step SC-7, when the flatbed cover open/close condition detecting unit 102f detects that the flatbed cover of the flatbed image reading unit 112 is closed by the flatbed cover open/close condition sensor 116 (Step SC-7: No), the ADF image-reading control unit 102d confirms whether there is a stack of document on the ADF image reading unit 114 (Step SC-9).

When there is a stack of document on the ADF image reading unit 114 (Step SC-9: Yes), the operation returns to Step SC-6, and the ADF image-reading control unit 102d controls the ADF image reading unit 114 to continue the reading of the document until the ADF image-reading control unit 102d confirms that there is no document to be read (Step SC-9: No).

As described above, the image reading apparatus 100 according to the present embodiment, suspends the reading of the document when it is detected that the flatbed cover is open, and then reads the read-condition setting sheet by using the flatbed image reading unit 112 when it is detected that the flatbed cover is closed, determines the read condition of the read-condition setting sheet, sets the read condition for the document according to the read condition that has been determined, and resumes the reading of the document according to the read condition that has been set. With such a configuration, the read condition can be changed as needed while reading the document even after the read condition is set, and it is possible to obtain a desired image corresponding to a type of a document to be read when reading the documents.

### Other Embodiments

While the present invention has been explained in terms with a specific embodiment, it should be understood that various modifications can be made to the present invention as alternative embodiments in addition to the embodiment as described above, and implemented without departing the scope, and technical idea of the appended claims.

In particular, while the above explanation describes the example that the processing is carried out by an integrated apparatus in which the image reading apparatus 100 includes the flatbed image reading unit 112, and the ADF image reading unit 114 integrated therein, an image reading apparatus having the flatbed image reading unit 112, and the ADF image reading unit 114, and an image-reading processing apparatus having the storage unit 106, and a control unit 102 can be configured as individual systems. Specifically, the image-reading processing apparatus can include the I/O control interface 108 connected to the image reading apparatus, the storage unit 106, and the control unit 102.

Further, while the above explanation describes the example that the image reading apparatus 100 carries out the processing in stand-alone mode, the image reading apparatus 100 can be configured as a network scanner that carries out the processing in response to a client terminal that is constituted as an individual system different from the image reading apparatus 100 over the network via a communication control interface, and returns processing result to the client terminal.

All the automatic processes explained in the present embodiment can be, entirely or in part, carried out manually. Similarly, all the manual processes explained in the present embodiment can be, entirely or in part, carried out automatically by a known method. The process procedures, the control procedures, specific names, information including registration data of each process and parameters of search condition etc., display example, database structure mentioned in the description and drawings can be changed as required unless otherwise specified.

The constituent elements of the image reading apparatus 100 are merely conceptual and may not necessarily physically resemble the structures shown in the drawings. For instance, the apparatus need not necessarily have the structure that is illustrated.

For example, the process functions performed by the image reading apparatus 100, especially regarding each of the process functions executed at the control unit 102, can be entirely or partially realized by a central processing unit (CPU) or a computer program executed by the CPU or by a hardware using wired logic. The computer program, recorded on a recording medium, can be mechanically read by the image reading apparatus 100 as the situation demands. In other words, the computer program recorded on the recording medium can cause the storage unit 106 such as read-only memory (ROM) or hard disk (HD) to work in coordination with the operating system (OS) to issue commands to the CPU and cause the CPU to perform various processes. The computer program is first loaded to the random access memory (RAM), and forms a control unit 102 in collaboration with the CPU.

Alternatively, the computer program can be stored in any application program server connected to the image reading apparatus 100 via the network, and can be fully or partially loaded as the situation demands.

“Computer-readable recording medium” on which the computer program can be stored may be a portable type such as flexible disk, magneto optic (MO) disk, ROM, erasable programmable ROM (EPROM), electrically erasable programmable ROM (EEPROM), compact disk-read-only memory (CD-ROM), digital versatile disk (DVD), or a communication medium that stores the computer program for a short term such as communication channels or carrier waves that transmit the computer program over networks such as local area network (LAN), wide area network (WAN), and the Internet.

“Computer program” refers to a data processing method written in any computer language and can have software codes and binary codes in any format. The computer program can be a dispersed form in the form of a plurality of modules or libraries, or can perform various functions in collaboration with a different program such as the OS. Any known configuration in the image reading apparatus according to the embodiment can be used for reading the recording medium. Similarly, any known process procedure for reading or installing the computer program can be used.

The storage unit 106 is a fixed disk device such as RAM, ROM, and hard disk or flexible disk, optical disk, and stores therein various programs, tables, databases required for various processes and opening websites.

The image reading apparatus 100 can also be connected to any existing personal computer, workstation, etc. and can be operated by executing software (that includes computer program, data, etc.) that implements the method according to the present invention in the personal computer or workstation.

Moreover, a specific manner of distribution, and integration of the apparatus is not limited to the example as described in the drawing. A part or all of the apparatus can be distributed or integrated functionally or physically in an arbitrary unit depending on various additions.

According to the present invention, it is not necessary to set reading resolution, and various setting parameters each time according to a type of a document to be read, thereby facilitating the setting of the read condition, and in turn reducing reading time required for reading a document.

Further, according to the present invention, a different batch process for reading can be carried out in parallel, thereby allowing an increase in the speed of an entire reading operation.

Further, according to the present invention, the read condition can be changed as needed while reading the document even after the read condition is set, and it is possible to obtain a desired image corresponding to a type of a document to be read when reading the documents.

Further, according to the present invention, it is possible to automatically determine, and set the read condition to read the document to be read.

Further, according to the present invention, it is possible to select either a normal reading mode in which an image is read, and then processed, or a high-speed reading mode in which an image of the next piece of the document is read while processing an image of the current piece of the document, as well as to select a reading resolution, a reading color, and a method of image processing that are suitable for the type of the document to be read, thereby allowing an increase in the speed of an entire reading operation as a result.

Further, according to the present invention, it is possible to read a read condition of a desired read-condition setting sheet suitable for the type of the document by opening a book-like instruction manual of the image reading apparatus including a collection of read-condition setting sheets to a page for the desired read-condition setting sheet using the flatbed image reading unit, in addition to a sheet-like read-condition setting sheet.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image reading apparatus comprising a flatbed image reading unit, an ADF image reading unit, a storage unit, and a control unit, wherein
the control unit includes:
a flatbed image-reading control unit that controls the flatbed image reading unit to read an image of a read-condition setting sheet, and stores the image of the read-condition setting sheet in the storage unit;
a read-condition determining unit that determines a read condition from the image of the read-condition setting sheet read by the flatbed image-reading control unit;
a read-condition setting unit that sets a read condition for a document to be read by the ADF image reading unit according to the read condition determined by the read-condition determining unit; and
an ADF image-reading control unit that controls the ADF image reading unit to read an image of the document according to the read condition set by the read-condition setting unit, and stores the image of the document in the storage unit.

2. The image reading apparatus according to claim 1, wherein the control unit further includes:
an image processing unit that processes the image of the document that read by the ADF image-reading control unit, and stores the image in the storage unit, wherein
during the processing of the image of the document by the image processing unit, the ADF image-reading control unit controls the ADF image reading unit to read a next image of the document, and stores the next image in the storage unit.

3. The image reading apparatus according to claim 1, wherein the control unit further includes:
a flatbed cover open/close condition detecting unit that detects whether a flatbed cover of the flatbed image reading unit is open or closed, wherein
when the flatbed cover open/close condition detecting unit detects that the flatbed cover is open, the ADF image-reading control unit suspends the reading of the document, and
when the flatbed cover open/close condition detecting unit detects afterward that the flatbed cover is closed, the flatbed image-reading control unit reads the read-condition setting sheet using the flatbed image reading unit, the read-condition determining unit determines the read condition of the read-condition setting sheet, the read-condition setting unit sets the read condition for the document according to the read condition that has been determined, and the ADF image-reading control unit resumes the reading of the document according to the read condition that has been set.

4. The image reading apparatus according to claim 1, wherein
the read condition described on the read-condition setting sheet is determined by the read-condition determining unit using one of optical character recognition, and pattern recognition.

5. The image reading apparatus according to claim 1, wherein
the read condition includes a condition that relates to at least one of setting of a reading mode, resolution, setting between black-and-white and color, and setting for black-and-white image processing.

6. The image reading apparatus according to claim 1, wherein
a form of the read-condition setting sheet is sheet-like or book-like.

7. An image-reading processing apparatus comprising a storage unit and a control unit, connected to an image reading apparatus comprising a flatbed image reading unit and an ADF image reading unit, wherein,
the image-reading processing apparatus includes:
a flatbed image-reading control unit that controls the flatbed image reading unit to read an image of a read-condition setting sheet, and stores the image of the read-condition setting sheet in the storage unit;
a read-condition determining unit that determines a read condition from the image of the read-condition setting sheet read by the flatbed image-reading control unit;
a read-condition setting unit that sets a read condition for a document to be read by the ADF image reading unit according to the read condition determined by the read-condition determining unit; and
an ADF image-reading control unit that controls the ADF image reading unit to read an image of the document according to the read condition set by the read-condition setting unit, and stores the image of the document in the storage unit.

8. The image-reading processing apparatus according to claim 7, wherein the control unit further includes:
an image processing unit that processes the image of the document read by the ADF image-reading control unit, and stores the image in the storage unit, wherein
during the processing of the image of the document by the image processing unit, the ADF image-reading control unit controls the ADF image reading unit to read a next image of the document, and stores the next image in the storage unit.

9. The image-reading processing apparatus according to claim 7, wherein the control unit further includes:
a flatbed cover open/close condition detecting unit that detects whether a flatbed cover of the flatbed image reading unit is open or closed, wherein
when the flatbed cover open/close condition detecting unit detects that the flatbed cover is open, the ADF image-reading control unit suspends the reading of the document, and
when the flatbed cover open/close condition detecting unit detects afterward that the flatbed cover is closed, the flatbed image-reading control unit reads the read-condition setting sheet using the flatbed image reading unit, the read-condition determining unit determines the read condition of the read-condition setting sheet, the read-condition setting unit sets the read condition for the document according to the read condition that has been determined, and the ADF image-reading control unit resumes the reading of the document according to the read condition that has been set.

10. An image reading method executed by an image reading apparatus comprising a flatbed image reading unit, an ADF image reading unit, a storage unit, and a control unit, wherein
the method comprises:
a flatbed image-reading control step of controlling the flatbed image reading unit to read an image of a read-condition setting sheet, and storing the image of the read-condition setting sheet in the storage unit;
a read-condition determining step of determining a read condition from the image of the read-condition setting sheet read at the flatbed image-reading control step;
a read-condition setting step of setting a read condition for a document to be read by the ADF image reading unit according to the read condition determined at the read-condition determining step; and
an ADF image-reading control step of controlling the ADF image reading unit to read an image of the document according to the read condition set at the read-condition setting step, and storing the image of the document in the storage unit.

11. The image reading method according to claim 10, wherein the method further comprises:
an image processing step of processing the image of the document that read at the ADF image-reading control step, and storing the image in the storage unit, wherein
during the processing of the image of the document at the image processing step, the ADF image-reading control step is executed for controlling the ADF image reading unit to read a next image of the document, and storing the next image in the storage unit.

12. The image reading method according to claim 10, wherein the method further comprises:
a flatbed cover open/close condition detecting step of detecting whether a flatbed cover of the flatbed image reading unit is open or closed, wherein
when the open condition that the flatbed cover is open is detected at the flatbed cover open/close condition detecting step, the reading of the document is suspended at the ADF image-reading control step, and
when the close condition that the flatbed cover is closed is detected afterward at the flatbed cover open/close condition detecting step, the read-condition setting sheet is read by using the flatbed image reading unit at the flatbed image-reading control step, the read condition of the read-condition setting sheet is determined at the read-condition determining step, the read condition for the document according to the read condition determined at the read-condition determining step is set at the read-condition setting step, and the reading of the document according to the read condition set at the read condition setting step is resumed at the ADF image-reading control step.

13. A computer program product having a computer readable medium including programmed instructions for executing an image reading method by an image reading apparatus comprising a flatbed image reading unit, an ADF image reading unit, a storage unit, and a control unit, wherein the instructions, when executed by a computer, cause the computer to perform:
a flatbed image-reading control step of controlling the flatbed image reading unit to read an image of a read-condition setting sheet, and storing the image of the read-condition setting sheet in the storage unit;
a read-condition determining step of determining a read condition from the image of the read-condition setting sheet read at the flatbed image-reading control step;
a read-condition setting step of setting a read condition for a document to be read by the ADF image reading unit according to the read condition determined at the read-condition determining step; and
an ADF image-reading control step of controlling the ADF image reading unit to read an image of the document according to the read condition set at the read-condition setting step, and storing the image of the document in the storage unit.
